(19) United States
(12) Patent Application Publication
(10) Pub. No.: US 2013/0291945 A1
(43) Pub. Date: Nov. 7, 2013

(54) CONTINUOUS PURGE SYSTEM FOR A STEAM TURBINE

(71) Applicants: Richard E. Warren, JR., Schenectady, NY (US); Tara A. Cole, Saratoga Springs, NY (US)

(72) Inventors: Richard E. Warren, JR., Schenectady, NY (US); Tara A. Cole, Saratoga Springs, NY (US)

(73) Assignee: GENERAL ELECTRIC COMPANY, Schenectady, NY (US)

(21) Appl. No.: 13/463,068

(22) Filed: May 3, 2012

(51) Int. Cl. F16K 15/00; F17D 1/00

(52) U.S. Cl. 137/1; 137/455

(57) ABSTRACT

The present application provides a continuous purge system for use with a stream turbine. The continuous purge system may include a one or more pressure sensors positioned about the steam turbine, one or more pressure lines in communication with the one or more pressure sensors, and a critical flow nozzle system. The critical flow nozzle system may include one or more critical flow nozzles in communication with the one or more pressure lines.

### TECHNICAL FIELD

The present application and the resultant patent relate generally to turbo-machinery such as a steam turbine and more particularly relate to a continuous purge system to keep water out of pressure sensor lines positioned about a steam turbine and the like.

### BACKGROUND OF THE INVENTION

Pressure loses may be determined by measuring pressures at various stages of a steam turbine operating under load conditions. These pressure loses may determine turbine efficiency, indicate compressor blade tip erosion, and/or relate to other types of operational parameters. Given such, a number of pressure sensors may be positioned about the stages of the steam turbine to provide the operator with sufficient feedback to react accordingly.

Steam, however, may condense into water and collect within the pressure lines associated with the pressure sensors. Steam may pass into the lines via diffusion of the steam and the air at the tube opening, because of pressure oscillations, because of leaks in the lines, and/or because of other causes. Water in the pressure lines may cause inaccurate pressure readings. As a result, purge air may be used to purge the pressure lines. Such purging may take a significant amount of time and may require a significant amount of airflow. The use of too much air, however, may make the operation of the condenser unsteady. Moreover, the purge air must be turned off during the pressure measurements and for an allotted settling time.

There is thus a desire for an improved air purge system for use with turbo-machinery such as steam turbines and the like. Such an improved air purge system may adequately keep the pressure lines of the steam turbine free of water for an extended period of time for the pressure sensors to provide accurate pressure measurements in a repeatable fashion.

### SUMMARY OF THE INVENTION

The present application and the resultant patent thus provide a continuous purge system for use with a stream turbine. The continuous purge system may include one or more pressure sensors positioned about the steam turbine, one or more pressure lines in communication with the one or more pressure sensors, and a critical flow nozzle system. The critical flow nozzle system may include one or more critical flow nozzles in communication with the one or more pressure lines.

The present application and the resultant patent further may provide a method of preventing water from entering a number of pressure lines and pressure sensors positioned about a steam turbine. The method may include the steps of purging the pressure lines with a source of purge air, stopping the source of purge air, measuring the pressure within the steam turbine with the pressure sensors, and flowing a flow of continuous purge air while the measuring step is on going. The flowing step may include flowing the continuous purge air through a critical flow nozzle.

The present application and the resultant patent further provide a continuous purge system for use with a stream turbine. The continuous purge system may include a number of pressure sensors positioned about the steam turbine and a number of critical flow nozzles. The pressure sensors may be communication with the pressure lines. The critical flow nozzles may be in communication with a flow of continuous purge air and the pressure lines.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a steam turbine.

FIG. 2 is a schematic view of a continuous purge system as may be described herein.

FIG. 3 is a schematic view of a critical flow nozzle that may be used with the continuous purge system of FIG. 2.

FIG. 4 is a schematic view of an alternative embodiment of a continuous purge system as may be described herein.

### DETAILED DESCRIPTION

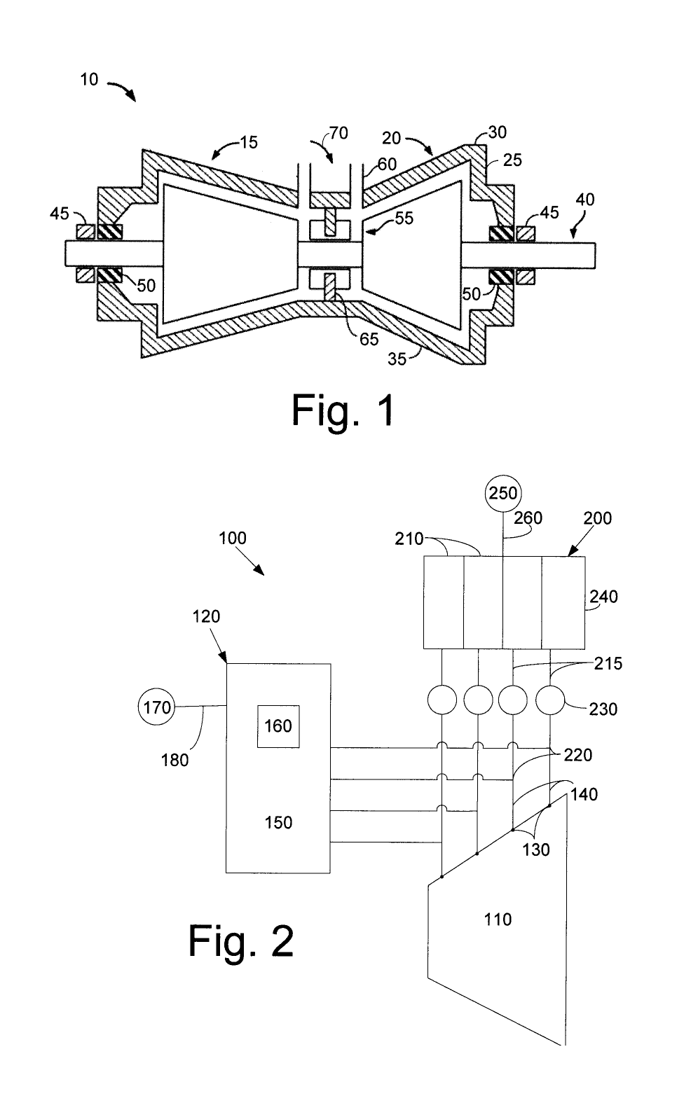

Referring now to the drawings, in which like numerals refer to like elements throughout the several views, FIG. 1 is a schematic diagram of an example of a steam turbine 10. The steam turbine 10 may include a first section 15 and a second section 20. The sections 15, 20 may be high pressure sections, intermediate pressure sections, and/or low pressure sections. Each of the sections 15, 20 may have a number of stages therein. An outer shell or casing 25 may be divided axially into upper and lower half sections 30, 35, respectively. A rotor 40 may extend through the casing 25 and may be supported by a number of journal bearings 45. A number of seals 50 also may surround the rotor 40 about the ends and elsewhere. A central section 55 may include one or more steam inlets 60. A flow splitter 65 may extend between the sections 15, 20 so as to split an incoming flow of steam 70 therethrough.

In use, the flow of steam 70 passes through the steam inlets 60 and into the sections 15, 20 such that mechanical work may be extracted from the steam by the stages therein so as to rotate the rotor 40. The flow of steam 70 then may exit the sections 15, 20 for further processing and the like. The steam turbine 10 described herein is for the purposes of example only. Steam turbines and/or other types of turbo-machinery in many other configurations and with many other or different components also may be used herein.

FIG. 2 shows an example of a continuous purge system 100 as may be described herein. The continuous purge system 100 may be used with a steam turbine 110. The steam turbine 110 may be similar to the steam turbine 10 described above and/or may include other types of turbo-machinery and the like. Any type of steam turbine 110 may be used herein. Multiple steam turbines 110 also may be used herein in different configurations.

The continuous purge system 100 may include a purge and measurement system 120 in communication with the steam turbine 110. The purge and measurement system 120 may include a number of pressure sensors 130 positioned about the steam turbine 110 for measuring pressure at different locations therein. The pressure sensors 130 may be piezoresistive sensors and the like. Other types of sensors may be used herein. The pressure sensors 130 may be connected by a number of pressure lines 140. The pressure lines 140 may be any type of standard air tubing and the like of any length or diameter.

The pressure lines 140 may lead to one or more purge and measurement cabinets 150. The purge and measurement cabinets 150 may have any size, shape, or configuration. The purge and measurement cabinet 150 may include one or more pressure transducers 160 therein in communication with the pressure sensors 130. Other types of measurement systems may be used herein. The purge and measurement cabinet 150 also may be in communication with a purge source 170. The purge source 170 provides a flow of purge air 180 to the pressure lines 140. The purge air 180 may include air, nitrogen, and the like. Other components and other configurations may be used herein.

The purge and measurement system 120 thus measures the pressure within the steam turbine 110 via the pressure sensors 130 and the pressure transducers 160. The pressure and measurement system 120 also provides the flow of purge air 180 to the pressure lines 140 to clear the pressure lines 140 of water therein. The purge and measurement system 120 may be fixed in place or portable. An example of a purge and measurement system 120 is sold by Scanivalve Corporation of Liberty Lake, Wash. including, but not limited to, Model DSA3218 and the like. Other types of purge and measurement systems may be used herein.

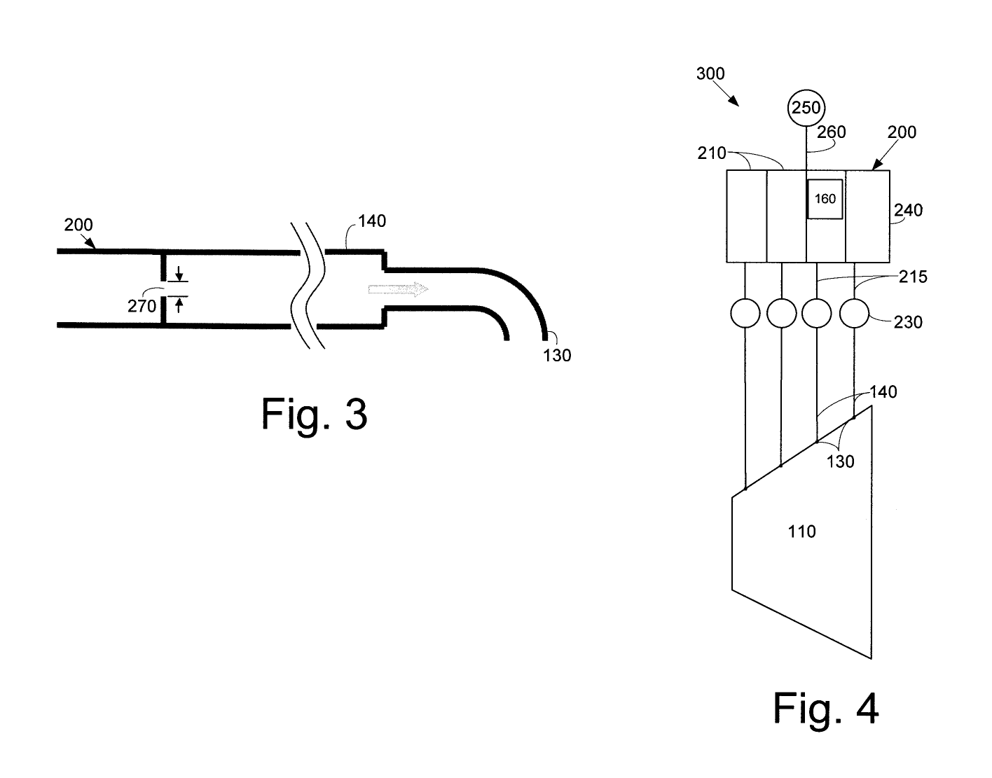

The continuous purge system 100 also may include a critical flow nozzle system 200 with a number of critical flow nozzles 210. As is shown in FIG. 2 and FIG. 3, the critical flow nozzles 210 may be positioned on each of the pressure lines 140 via a nozzle line 215 intersecting at a T-joint 220. The nozzle lines 215 may have any length or diameter. Likewise, the T-joints 220 may have any configuration and other types of connections may be used herein. A flow control valve 230 may be positioned on each of the nozzle lines 215. The flow control valve 230 may be any type of on/off nozzle. (The flow control valves 230 are only required if the ability to turn the continuous purge system 100 on and off is desired.) The critical flow nozzles 210 may be positioned within a nozzle block 240 or other type of support structure. The nozzle block 240 may have any size, shape, or configuration. The critical flow nozzles 200 within the nozzle block 240 may be in communication with a continuous purge source 250 with a flow of continuous purge air 260. The continuous purge source 250 may be the same or different as the purge source 170. Moreover, ambient air also may be used if the turbine pressure is well below atmospheric. One or more filters also may be used to ensure a clean purge source. Other components and other configurations may be used herein.

FIG. 3 shows an example of the continuous flow nozzle 200. The continuous flow nozzle 200 may have an internal orifice 270 positioned therein. The orifice 270 may be sized on the order of about two (2) to about ten (10) microns or so in diameter although any size may be used herein. The continuous flow nozzle 200 may provide a substantially constant flow across the internal orifice 270 given a greater upstream pressure. The mass flow rate of continuous purge air 260 thus need only be relatively small to ensure that water does not collect within the pressure lines 140. The flow of continuous purge air 180 thus may have a negligible impact on the operation of the steam turbine 110. Other components and other configurations also may be used herein.

In use, the continuous purge system 100 may use the purge and measurement system 120 to purge the pressure lines 140 in the usual fashion. The continuous purge system 100 may keep the flow control valves 230 of the critical flow nozzle system 200 closed when the purge and measurement system 120 is in use. The flow of purge air 180 then may be stopped and the pressure measurements may begin with the pressure sensors 130 and the pressure transducers 160 or other types of data collection devices. After a certain amount of time has elapsed and while the data is still being collected, the flow control valves 230 of the critical flow nozzle system 200 may be opened. The critical flow nozzles 200 may provide the flow of continuous purge air 260 to the pressure lines 140 so as to prevent water from entering therein while measurements are on-going. The flow control valves 230 of the critical flow nozzle system 200 may be closed when the measurements are complete or at some point before completion. The critical flow nozzle system 200 also may be operated intermittently. Other methods may be provided herein with different method steps in any other.

The pressure measured by the pressure sensors 130 thus would include the actual turbine pressure plus the pressure head required to drive the small mass flow of the flow of continuous purge air 260. Because this mass flow rate may be relatively small and constant, this pressure head may be negligible and/or correctible. In other words, just enough of the flow of continuous purge air 260 may be used to keep water out of the pressure lines 140 during measurements but not enough to have an impact on the measurements and/or the impact may be known and accommodated.

The continuous purge system 100 thus improves overall turbine operating stability. The continuous purge system 100 provides the use of both conventional purge via the purge and measurement system 120 and/or continuous purge via the critical flow nozzle system 200. Moreover, pressure measurements may be taken more quickly and more precisely. The known extended purge cycles thus may be considerably shortened. Specifically, faster test running, less complicated instrument setup, and improved data quality may be provided herein.

FIG. 4 shows a further example of a continuous purge system 300 as may be described herein. In this example, the purge and measurement system 120 is removed and only the critical flow nozzle system 200 may be used. Given such, the pressure transducers 160 may be moved to the nozzle block 240 or elsewhere. The continuous purge system 300 thus may continuously provide the flow of purge air 260 to the pressure lines 140. Other components and other configurations may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A continuous purge system for use with a stream turbine, comprising:
one or more pressure sensors positioned about the steam turbine;
one or more pressure lines in communication with the one or more pressure sensors; and
a critical flow nozzle system;
the critical flow nozzle system comprising one or more critical flow nozzles in communication with the one or more pressure lines.

2. The continuous purge system of claim 1, further comprising a purge and measurement system in communication with the one or more pressure lines.

3. The continuous purge system of claim 2, wherein the purge and measurement system comprises a purge source with a flow of purge air in communication with the one or more pressure lines.

4. The continuous purge system of claim 2, wherein the purge and measurement system comprises a cabinet.

5. The continuous purge system of claim 1, further comprising one or more pressure transducers in communication with the one or more pressure sensors.

6. The continuous purge system of claim 1, wherein the one or more critical flow nozzles comprises an orifice therein.

7. The continuous purge system of claim 6, wherein the orifice comprises about two (2) to about ten (10) microns in diameter.

8. The continuous purge system of claim 1, wherein the critical flow nozzle system comprises one or more nozzle lines in communication with the one or more critical flow nozzles and the one or more pressure lines.

9. The continuous purge system of claim 8, wherein the one or more nozzle lines and the one or more pressure lines meet at a T-joint.

10. The continuous purge system of claim 8, wherein the one or more nozzle lines comprise a flow control valve thereon.

11. The continuous purge system of claim 1, wherein the critical flow nozzle system comprises a continuous purge source with a flow of continuous purge air therein in communication with the one or more critical flow nozzles.

12. The continuous purge system of claim 1, wherein the critical flow nozzle system comprises a nozzle block with the one or more critical flow nozzles therein.

13. The continuous purge system of claim 1, wherein the one or more pressure lines are positioned about a number of stages of the steam turbine.

14. A method of preventing water from entering a number of pressure lines and pressure sensors positioned about a steam turbine, comprising:
purging the pressure lines with a source of purge air;
stopping the source of purge air;
measuring the pressure within the steam turbine with the pressure sensors; and
flowing a flow of continuous purge air while the measuring step is on going.

15. The method of claim 14, wherein the flowing step comprises flowing the continuous purge air through a critical flow nozzle.

16. A continuous purge system for use with a stream turbine, comprising:
a plurality of pressure sensors positioned about the steam turbine;
the plurality of pressure sensors in communication with a plurality of pressure lines;
a plurality of critical flow nozzles;
the plurality of critical flow nozzles in communication with a flow of continuous purge air and the plurality of pressure lines.

17. The continuous purge system of claim 16, wherein the plurality of pressure sensors are in communication with a plurality of pressure transducers.

18. The continuous purge system of claim 16, wherein the plurality of critical flow nozzles each comprises an orifice therein.

19. The continuous purge system of claim 18, wherein the orifice comprises about two (2) to about ten (10) microns in diameter.

20. The continuous purge system of claim 16, wherein the plurality of critical flow nozzles are in communication with a plurality of nozzle lines which, in turn, are in communication with the plurality of pressure lines.
